(19) United States
(12) Patent Application Publication
(10) Pub. No.: US 2009/0089408 A1
(43) Pub. Date: Apr. 2, 2009

(54) XML Router and method of XML Router Network Overlay Topology Creation

(75) Inventors: Bashar Bou-Diab, Ottawa (CA); Khurram Masood, Ottawa (CA); Ashraf Matrawy, Kanata (CA)

Correspondence Address: MARKS & CLERK, P.O. BOX 957, STATION B, OTTAWA, ON, K1P 5S7, CA

(73) Assignee: ALCATEL LUCENT, Paris (FR)

(21) Appl. No.: 11/905,246

(22) Filed: Sep. 28, 2007

(51) Int. Cl. G06F 15/173

(52) U.S. Cl. 709/220; 709/224

(57) ABSTRACT

A system and method are provided for creating an XML network. As each XML router is added to the XML network, the new XML router registers with a group of existing XML routers in the network, and thereafter regularly exchanges hello messages with other XML routers in order to announce its initial and continued presence. Once an XML router is added to the group of routers forming the network, the adjacency of the new XML router is determined. The new XML router selects its adjacency based on a prioritized set of metrics, including TCP hops, IP cost, and fanout, along with specific parameters relating to fanout and IP cost. The order of priority of the metrics and the specific parameters can be set by an operator, allowing flexibility in creating an optimum XML network topology.

### FIELD OF THE INVENTION

The invention relates to application layer networking, and more particularly to creation of XML (extensible Markup Language) network topology.

### BACKGROUND OF THE INVENTION

Content-based networks provide distribution of content from providers to subscribers. In content based networks implemented with XML (extensible Markup Language), distribution of said content from the providers to the subscribers occurs through the use of application level XML routers which at the application level ensure that the appropriate content is routed to the appropriate subscribers. As with any network, the procedure used to establish connectivity between routers and the resulting topology have a profound effect upon the effectiveness and efficiency of the network.

In known systems, network topology is typically created in such a manner that each of the subscribers can potentially receive content from each of the providers. As a result most topologies of the prior art content based networks were full mesh topologies or variations thereof. Full mesh topology in a content based application layer network implies a large amount of replication effort which creates delay and overburdens resources.

XML routed communication realizes a many-to-many push communication facility that uses dynamic XML content addresses (the content is an interface group address) and decouples sources (publishers) from receivers (subscribers) with a network of XML routers (directory). The terms “XML routing” and “XML multicast routing” are used interchangeably in the industry. The XML routing engine performs aggregation and distribution of complex semantic routing policies among XML routers connected via an IP network. These semantic routing policies which are maintained by the XML routing control plane are enforced by XML routers at the data plane for streaming XML data at high speed.

XML routing enables the publish/subscribe communication model to distribute real-time events through distributed systems on wide area networks. XML routed networking provides content-based publish-subscribe communication without requiring application specific integration with the network. In an XML routed network, receivers declare their interests using the subscribe process, senders simply publish messages, and the network takes care of delivering the messages from the senders to subscribed receivers. Senders and receivers need not know about each other nor is a connection needed between a sender and a receiver. The network is responsible for intelligently matching new messages to existing subscriptions and delivering the information to relevant subscribers.

XML routers employ XML routing and XML forwarding algorithms for XML traffic handling. Analogous to conventional networking, XML routing amounts to synthesizing XML content distribution paths across the network while XML forwarding involves determining at each XML router the set of next hop XML-aware devices. XML routing enables reliable real-time many-to-many push communications in a flexible manner over a large network.

Subscriptions are the bases of XML publish-subscribe communication since they are used to construct routing information. An XML content subscription is a logical constraint on document structure (path expression) or attribute(s) value(s) requesting XML documents matching these logical constraints to be forwarded to the subscribing node, or on the interface of the subscription. An XML document contains elements, which contain attributes, other elements, and text. XPath provides a standard language for expressing XML document subscriptions and a standard expression syntax for locating XML elements within XML documents. At an XML router, the outgoing interfaces or next hops of a message are determined by matching the content of the message against logical content constraints in a content-routing database. The content-routing database is constructed from the subscriptions, each being a set of attribute-value constraints, of the neighbor nodes indicating messages of interest. The XML-routed communication service consists of delivering a message to all XML nodes whose advertised constraints encompass the message attributes.

An XML routed network is a point-to-point, application level overlay consisting of network hosts and routers. Although point-to-point connections between XML nodes may require that each XML node has a set of unique Layer 3 network addresses to allow the construction of the XML network overlay, the use of Layer 3 network addresses is limited to the Layer 3 network. At the XML routing layer, each node may be assigned a Unique Resource Identifier to assist in message delivery over the Layer 3 network, however messages are not addressed to destination network node(s) explicitly. Instead, each message has a number of attribute-value pairs, such as the topic attribute for routing in a topic-based publish-subscribe system. XML routed networks provide a form of communication whereby the flow of messages from sources to destinations is determined primarily by the message content rather than an explicit addressing.

At the control plane of an XML routed network, XML routing is responsible for distributing and maintaining receiver subscriptions. XML routing involves (1) propagation of topological information to establish the XML overlay network, (2) aggregation of XML constraint subscriptions received from neighbor nodes, and (3) distribution of XML context subscriptions (selection predicates) among XML routers in the XML network overlay.

The rapid adoption of the XML data model and Web Services has triggered the commercialization of a large number of XML-aware networking devices such as XML firewalls, XML routers, and XML transformation accelerators. Up to this date XML routing protocols, which form the control plane of XML routers, remain proprietary to private companies.

Recently, XML has become of interest for publish-subscribe networks due to its widespread adoption in the application world. However, the infancy of XML routing is evident in the lack of standardized XML routing protocols and the lack of experience with XML routed networks. The utility of XML routing in the context of new XML-based network services lies in customized content push distribution, distributed event monitoring networks, publish-subscribe Web services, secure reliable multicast, and application XML VPNs.

Examples of AON/XAN devices that utilize XML routing are Cisco's AON cards, Solace Systems XCR 3200, Sarvega's XML Context Router, and IBM Datapower product family.

Current content based application layer networking systems are not designed to scale well as the size of the network grows especially in the context of the heavy processing demands of distributed XML messaging. Other content based application layer networking solutions, such as IP multicast used for one-to-many broadcast, do not lend themselves to the dynamic real-time demands of a content based publish-subscribe system such as XML messaging.

### SUMMARY OF THE INVENTION

According to one aspect, the invention provides a method for creating an extensible mark-up language (XML) network. A new XML router is added to a group of existing XML routers by registering the new XML router with a rendezvous point of an XML router discovery group. A hello message is intermittently broadcast from each XML router to all other XML routers in the group. At each XML router, a timer is maintained in association with each of at least one adjacent XML router. If a timer expires at one of the XML routers before receipt of a hello message from the adjacent XML router associated with the timer, the fact that the adjacent XML router is no longer a neighbour of the XML router on which the timer expired is broadcast to all other XML routers.

One of the existing XML routers may be selected by determining which of at least two XML routers best satisfy prioritized metrics. Adjacency between the new XML router and the selected existing XML router may then be established.

According to another aspect the invention provides a method for adding an XML router to an existing XML network having at least one existing XML router. One of the existing XML routers is selected by determining which of at least two XML routers best satisfy prioritized metrics. Adjacency between the new XML router and the selected XML router is then established.

The methods of the invention allow creation of an XML network, or more generally any content based application layer network in which publish-subscriber or advertize-publish-subscribe messaging is used. XML router discovery and monitoring is used to manage network topology. Topology generation utilizes three network metrics to establish network element adjacency, enabling dynamic growth of the XML network. By allowing a network administrator to prioritize the network metrics, the topology of the XML network can be created automatically and still have the characteristics desired by the administrator.

### BRIEF DESCRIPTION OF THE DRAWINGS

The features and advantages of the invention will become more apparent from the following detailed description of the preferred embodiment(s) with reference to the attached figures, wherein:

FIG. 1A-C are a flowchart of methods by which XML router discovery is effected according to one embodiment of the invention;

FIG. 2 is a diagram of a hello message format used in the methods of FIG. 1 according to one embodiment of the invention;

FIG. 3 is a schematic diagram of an example XML network to which a new XML router is to be added;

FIG. 4A-C illustrate example tables used to prioritize metrics for determining router adjacency according to one embodiment of the invention;

FIG. 5 is a flowchart of a method by which adjacency is determined for an XML router being added to an XML network according to one embodiment of the invention;

FIG. 6 is a flowchart of the preliminary setup of FIG. 5 according to one embodiment of the invention;

FIG. 7 is a flowchart of determination of TCP hops priority according to one embodiment of the invention;

FIG. 8 is a flowchart of determination of IP cost priority according to one embodiment of the invention;

FIG. 9 is a flowchart of determination of fanout priority when the fanout priority is “greatest fanout” according to one embodiment of the invention;

FIG. 10 is a flowchart of determination of fanout priority when the fanout priority is “least fanout” according to one embodiment of the invention;

FIG. 11 is a flowchart of determination of fanout priority when the fanout priority is “target fanout” according to one embodiment of the invention; and

FIG. 12 is a flowchart of the tie break method of FIG. 5 according to one embodiment of the invention.

It is noted that in the attached figures, like features bear similar labels.

### DETAILED DESCRIPTION OF THE PREFERRED EMBODIMENTS

Broadly, an XML network is created using XML router discovery and monitoring to manage network element membership, and using prioritized network metrics to establish network element adjacency when creating the XML network topology. XML router discovery and monitoring is achieved by intermittent broadcasting of hello messages from each XML router, each hello message including an identification of XML routers which are neighbours of the XML router which broadcast the hello message. Each XML router maintains a timer for each of its neighbour XML routers. If a timer expires before receipt of a hello message from the adjacent XML router associated with the timer, then the XML router maintaining the timer broadcasts to all other XML routers that the XML router associated with the timer is no longer a neighbour of the XML router maintaining the timer.

In order to create the XML network topology, adjacency is established between a newly added XML router and an existing XML router. The newly added XML router selects an existing XML router by evaluating at least two XML routers using prioritized metrics. Adjacency is established with the XML router which best satisfies the prioritized metrics.

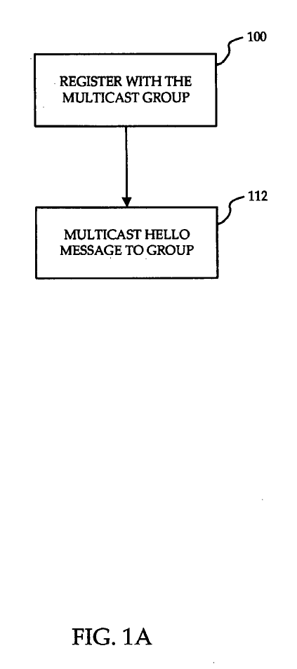

Referring to FIGS. 1A to 1C, a method of XML router discovery utilizing a multicast group according to one embodiment of the invention is shown. The method is implemented when an XML router is added to a group of existing XML routers (which group may of course include just one XML router while the group is being “built”), and thereafter in order to maintain knowledge of XML routers within the group. Each XML router which is to be added to the XML network joins a multicast group which has a unique IP multicast address for all of the XML routers of the XML network. In this technique all of the routers within the multicast group exchange network control information. Since XML routers may be spread over the Internet, the preferred embodiment utilizes the Protocol Independent Multicast (PIM-SM) routing protocol. Each XML router uses IGMP to communicate requests for group membership to its designated source IP multicast router. Group management, including addition and deletion of XML routers to and from the multicast group, is maintained according to the multicast routing protocols (PIM-SM, IGMP). According to these protocols the XML routers register themselves with a rendezvous point which is a root of the distribution tree formed by PIM-SM. All XML routers must do this in order to communicate important discovery information.

It should be noted that the multicast group of the preferred embodiment is set up over an IP multicast channel over many IP hops as opposed to the traditional one physical hop or multiple Ethernet hops of OSPF.

In FIG. 1A, a new XML router registers with the rendezvous point at step 110. Once the XML router is registered with the multicast group, the XML router broadcasts a hello message to the group at step 115.

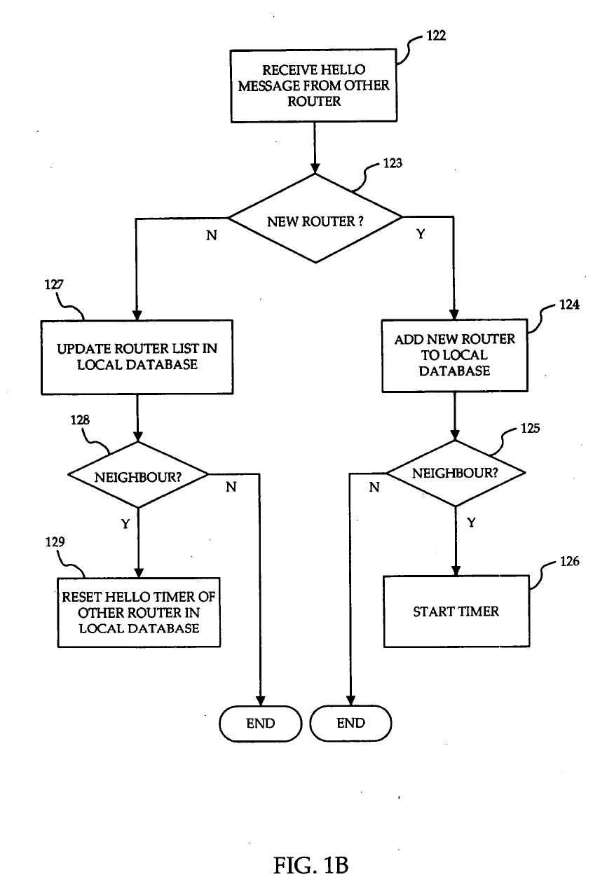

Referring to FIG. 2, a format of the hello message sent by the XML router according to one embodiment of the invention is shown. Each hello message contains important information such as the XML router's URI (unique resource identifier) 114, its IP address 115, its hello timers 116, its TSA (time since alive) 117, its fanout 118, its TCP hops 119, and its current neighbour list 120. The hello timers 116 include a DEAD timer for each neighbour router which specifies a period of time which must pass before declaring that the neighbour router is down, and an internal timer which specifies a period of time between sending subsequent hello messages to the multicast group. The TSA 117 is useful for establishing how long the XML router has been a member of the multicast group and hence part of the XML network and is used primarily to differentiate existing XML routers from new XML routers. The TCP hops 119 is the maximum number of TCP hops needed to reach other XML routers in the group. When a new XML router first joins a group, the value of the TCP hops field in the initial hello message will be “0”, until it learns the topology of the XML network and learns its neighbours. The current neighbour list 120 lists all of the adjacent XML routers established by their URIs. Neighbours are initially determined by establishing adjacency of a newly added XML router, for example as described below.

In addition to the hello message sent at the time that a new XML router registers with the multicast group, each XML router regularly broadcasts a hello message to all the other XML routers of the XML network based on its internal hello timer. In an exemplary embodiment of the invention, all of the XML routers of the XML network have the same hello timer parameters. Referring to FIG. 1B, the procedure taken by an XML router upon receipt of a hello message according to one embodiment of the invention is shown. At step 122 the XML router receives a hello message from another router. At step 123 the XML router determines whether the URI of the other router is a new router by checking its local database which lists all of the XML routers of the XML network, each XML router in the local database being identified by its URI. If the URI 114 in the hello message is not listed in the local database, then the XML router which sent the hello message is a new XML router. If the URI 114 in the hello message is already listed in the local database, then the XML, router which sent the hello message is not a new XML router.

If the other router is a new router, the XML router adds the new router to the local database at step 124 by adding the URI of the other router to its local database. At step 125 the XML router determines whether the other router is a neighbour. If so, then at step 126 the XML router starts a hello timer associated with the other router, which is the time period after which the XML router will declare the other router as inactive if no subsequent hello messages are received from the other router. If the other router is not a neighbour, then the XML router finishes processing the hello message. If at step 123 the XML router determines that the other router is not a new router, then at step 127 the XML router updates the router list of URIs in its local database with the list of URIs in the received hello message. At step 128 the XML router determines whether the other router is a neighbour, and if so then at step 129 the XML router resets a hello timer associated with the other router in its local database. If at step 128 the XML router determines that the other router is not a neighbour, then the XML router finishes processing the hello message.

Referring to FIG. 1C, a method carried out by an XML router upon expiry of a hello timer which is associated with another router according to one embodiment of the invention is shown. As described above with reference to steps 126 and 129 of FIG. 1B, each XML router maintains a timer for each neighbour XML router in the XML network. At step 130 the hello timer associated with another router expires. According to the preferred embodiment, each router may only be determined as expired by its direct neighbor routers, namely, those which are one TCP hop or one application layer hop away from the router. At step 134 the XML router removes the URI of the other router from its local database at. At step 136, the XML router multicasts to the XML network a hello message which contains the updated router list, which includes the fact that the other router is no longer a neighbour of the XML router. As is described above with reference to step 127 of FIG. 1B, each XML router receiving a hello message from another existing router updates its local database using the URI list in the received hello message.

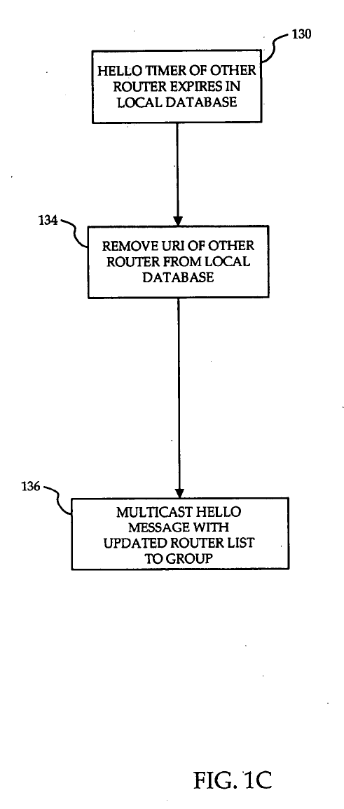

Once an XML router has been added to a group, the newly added XML router chooses which other XML router to establish adjacency with. Referring to FIG. 3, an example XML network to which a new XML router is added is shown. The XML network 11 includes seven XML routers (A to G) variously connected by application layer connections 20, and a new XML router N is to be added. In order to add the new XML router N, an adjacency of the new XML router N is determined. In other words, one of the existing routers A to G is selected as the initial neighbour router of router N. By successively adding new XML routers and determining the adjacency of each new router, the XML network topology is built.

During the process of building the network, the system takes into account three metrics to decide which of the existing XML routers should be established as adjacent to each new router added to the network. These metrics are a TCP hops metric (or more generally an application layer hop metric), an IP cost metric, and a fanout metric.

The TCP hops metric assigns a TCP hops number to each of the existing routers with which the new XML router may establish adjacency. The TCP hops assigned to a potential neighbour XML router is the minimum number of application layer hops (number of XML routers traversed) needed to reach the farthest perimeter router from that potential neighbour XML router. For example, in the XML network shown in FIG. 3, the TCP hops metric for existing XML router G is four, since this is the number of hops (denoted by dashed arrow 14 in FIG. 3) needed to reach XML router E, the furthest XML router. The TCP hops metric for existing router F is three, since this is the number of hops needed to reach either XML router G or XML router E.

The IP cost metric assigns an IP cost to each of the existing routers with which the new XML router may establish adjacency. IP cost in general may be measured using any number of possible known IP cost metrics and preferably any IGP metric. In other embodiments of the invention a round trip time for messages to traverse between the new XML router and the existing router measured in milliseconds (msec) is used.

The fanout metric assigns a fanout to each of the existing routers with which the new XML router may establish adjacency. The fanout of a router is the number of adjacencies it has established with other routers of the XML network. For example, the fanout of XML router D in FIG. 3 is two.

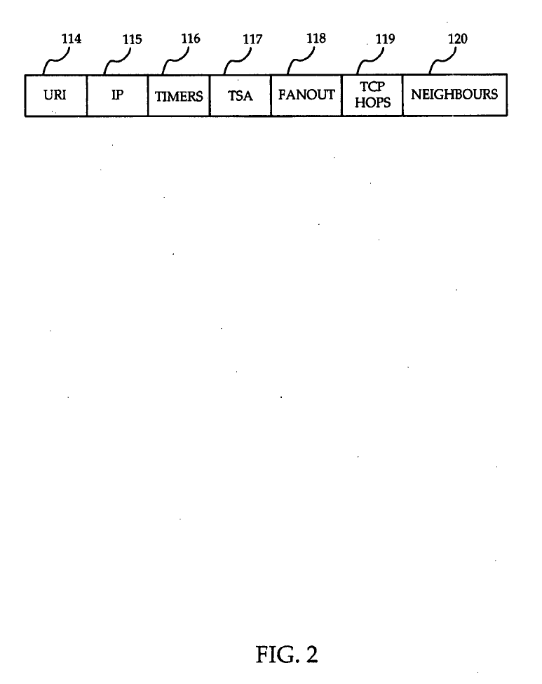

In association with metrics are a number of parameters which an operator may set. The first set of parameters set by an operator are the prioritization parameters. The prioritization parameters are a prioritization of the three metrics discussed above, and a type of fanout prioritization. Referring to FIG. 4A, an example set of prioritization parameters is shown. The prioritization parameters include a first priority 30, which identifies the metric to be given the highest priority when determining adjacency of a new XML router. The prioritization parameters also include a second priority 31 and a third priority 32, which identify the metrics to be given the second highest and third highest priority when determining adjacency of a new XML router, respectively. The prioritization parameters also include a type of fanout prioritization 33, which identifies how the fanout priority is to be determined.

When determining the connectivity for a newly added XML router, the operator arranges the three metrics into three ordered priorities and defines the fanout prioritization type. In the example prioritization parameters shown in FIG. 4A, the operator has set the IP cost of reaching a neighbour as the highest priority, followed by the TCP hops of the neighbour and then by the fanout of the neighbour. The fanout prioritization type has been set to “least fanout”. When the adjacency of the new XML router is being determined, each of the priorities are used in turn to decide with which of the existing XML routers adjacency the newly added router is to be established. The metric assigned first priority 30 (IP cost in the example of FIG. 4A) is analyzed first, the metric assigned second priority 31 is analyzed second, and the metric assigned third priority 32 is analyzed third. When determining the XML router which best satisfies the fanout (the third priority in the example of FIG. 4A), the fanout prioritization type 33 is considered (“least fanout” in the example of FIG. 4A).

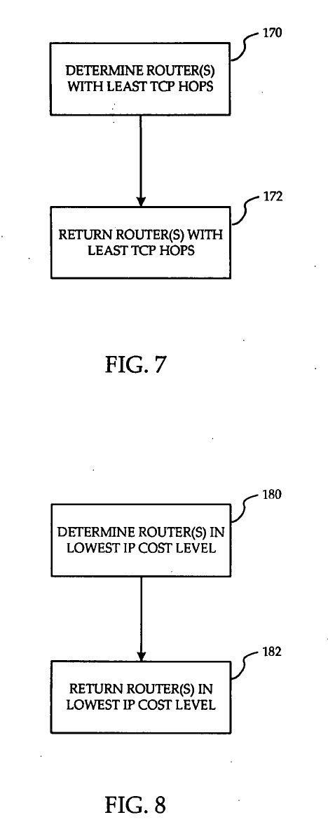

The fanout prioritization type can be of three types and is chosen by an operator. The way in which the fanout is used while building the network topology will differ depending upon the fanout prioritization type. The operator will typically choose the particular type needed by the network based on, for example, the nature of the XML routers and the desired general type of topology preferred. These three types of fanout priority are: greatest fanout; least fanout; and target fanout. If the fanout parameterization type is target fanout, then a target fanout value is also defined. These are described in more detail below with reference to FIG. 9 to 11.

A second set of parameters is a maximum fanout parameter defined for each XML router, which specifies the maximum number of application layer connections allowed for the XML router. In other words, the maximum fanout parameter is the maximum number of other routers with which it can establish adjacency. The XML routers need not all have the same maximum fanout parameter. The maximum fanout parameter for each XML router is preferably defined by the operator.

A third set of parameters which can be defined by the operator defines a number of IP cost levels for grouping IP costs measured during building of the network. Referring to FIG. 4B an example set of IP cost levels is shown. Each IP cost level 34 has a minimum 35 and a maximum value 36. Each IP cost level has a unique IP cost range which does not overlap with the IP cost range of any other IP cost level. There are no gaps in the IP cost ranges, so that every realistic IP cost will belong to one of the IP cost ranges. In the example shown in FIG. 4B, two IP cost levels have been defined: IP cost level 1 with a minimum value of 1 msec and a maximum value of 45 msec, and IP cost level 2 with a minimum value of 45 msec and a maximum value of 100 msec. The IP cost levels are used to bin the IP cost metrics of the potential neighbour XML routers. In this way, two XML routers whose IP cost differs by only one or two msec will likely be treated as having equivalent IP costs.

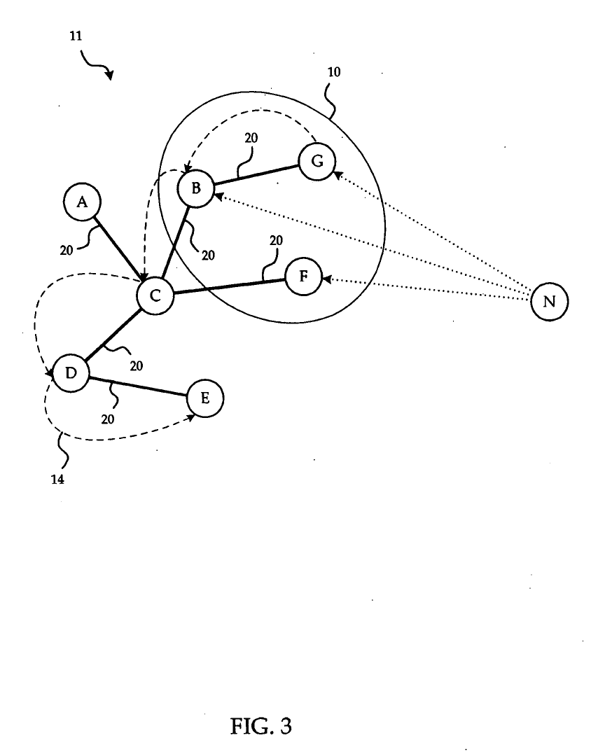

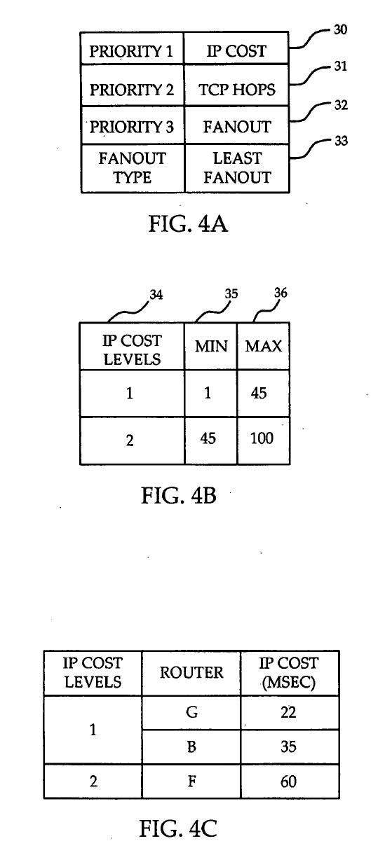

Referring to FIG. 5, a method by which an XML router is added to an existing XML network is shown according to one embodiment of the invention. The method is preferably carried out by the control plane of the new XML router. The operator has already defined at least the prioritization parameters, the maximum fanout parameter defined for each XML router, and the IP cost levels. At step 140 a preliminary setup is performed, in which various values to be used in the rest of the method are determined. Referring to FIG. 6 a method of performing the preliminary setup is shown according to one embodiment of the invention. At step 142 the existing XML routers which have a current fanout less than their respective maximum fanout are determined. In the example network of FIG. 3, let routers A and E each have a maximum fanout parameter of one, XML router D have a maximum fanout parameter of two, XML routers B, F, and G each have a maximum fanout parameter of three, and XML router C have a maximum fanout parameter of four. Since routers A, C, D, and E have already reached their maximum fanouts they do not qualify for adjacency with the new router N and are not determined to be part of the subset. Each of routers B, F, and G, however, has a current fanout which is less than its respective maximum fanout parameter. These routers therefore belong to the subset 10 which is determined at step 142.

For each router in the subset of routers having less than its maximum fanout, an IP cost is calculated at step 144 and the router placed in one of the IP cost levels as defined by the operator as described above. In the preferred embodiment of the invention, the IP cost of each of the routers in the subset 10 is calculated from the round trip time it takes for the hello message sent by the new router N to be answered by a hello message from each of the routers in the subset 10. In the example network of FIG. 3, let XML router G have an IP cost of 22 msec with respect to new router N, XML router B have an IP cost of 35 msec, and XML router F have an IP cost of 60 msec. Using the example IP cost levels shown in FIG. 4B, the XML routers B, F, and G are placed into the two IP cost levels. The IP cost and the IP cost level for each of the routers in the subset 10 is stored locally at the new XML router as a table, as shown in the example table of FIG. 4C.

At step 146 the maximum number of TCP hops to the perimeter of the network is calculated for each of the routers determined as having less than its respective maximum fanout. The TCP hops of each XML router of the network is conveyed to the new XML router N in the TCP hops 119 value in the respective hello message received from that XML router. In the example network of FIG. 3, XML router G has a TCP hops value of four, and XML routers B and F each has a TCP hops value of three.

Finally, before proceeding to the first priority as defined by the operator, the current fanout is calculated at step 148 for each of the routers determined as having less than its respective maximum fanout. The fanout of each XML router is conveyed to the new XML router N in the fanout value 118 in the respective hello message received from that XML router. In the example network of FIG. 3, XML routers G and F have a fanout of one, and XML router B has a fanout of two.

Once the new XML router has all of the information regarding the IP cost, IP cost level, TCP hops, and fanout of each existing XML router of the XML network, the new XML router proceeds to decide with which of the existing XML routers to establish adjacency. This is determined by evaluating the prioritized metrics of each of the potential neighbour XML routers in the subset 10 of routers having less than their respective maximum fanout. Returning to FIG. 5, the new XML router evaluates at step 150 each potential neighbour XML router using the metric defined as the first priority 30 in the prioritization parameters. If only one XML router is determined at step 152 as satisfying the first priority, then the new XML router establishes adjacency with that single XML router at step 154.

If more than one XML router is determined at step 152 as satisfying the first priority, then at step 156 the new XML router evaluates each of those potential neighbour XML routers which satisfy the first priority by using the metric defined as the second priority 31. If only one of those XML routers is determined at step 158 as satisfying the second priority, then the new XML router establishes adjacency with that single XML router at step 154.

If more than one XML router is determined at step 158 as satisfying the second priority (and hence also the first priority), then at step 160 the new XML router evaluates each of those potential neighbour XML routers which satisfy both the first priority and the second priority by using the metric defined as the third priority 32. If only one of those XML routers is determined at step 162 as satisfying the third priority, then the new XML router establishes adjacency with that single XML router at step 154.

If more than one XML router is determined at step 162 as satisfying the third priority (and hence also the first and second priorities), then at step 164 the new XML router evaluates each of those potential neighbour )(ML routers which satisfy all three priorities by using a tie-breaking mechanism. The tie-breaking mechanism determines a single XML router, and the new XML router establishes adjacency with that single XML router at step 154.

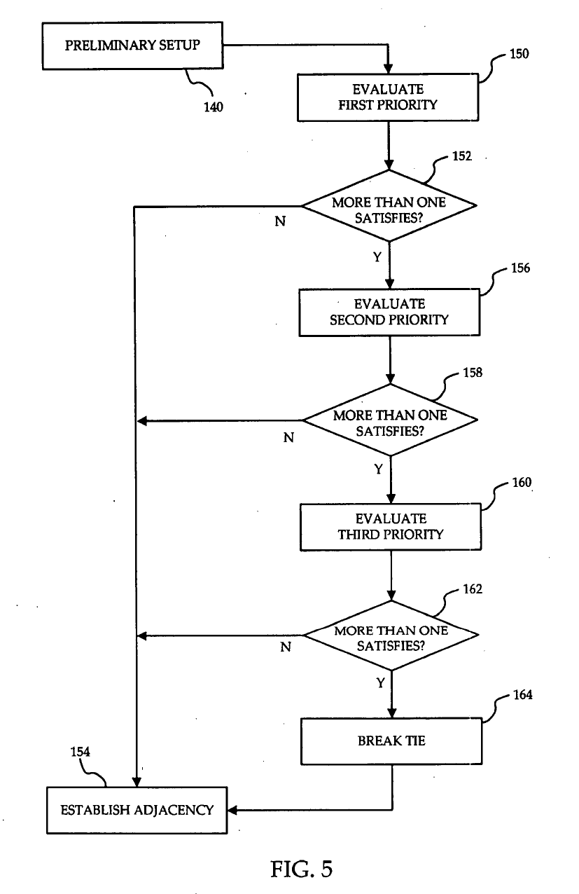

Referring to FIG. 7 to 11, methods by which priorities are determined for each of the metrics and fanout prioritization types is shown according to one embodiment of the invention. These methods are variously executed as steps 150, 156, and 160 of FIG. 5, depending on the prioritization of the three metrics and the fanout prioritization type previously defined by the operator. Each method operates on a limited set of the XML routers. The set of XML routers is limited first to the XML routers having a current fanout less than their respective maximum fanouts, determined as described above with reference to step 142 of FIG. 6, and then further limited by any earlier priority evaluations. The set of XML routers evaluated under the first priority is limited to those XML routers having a current fanout less than their respective maximum fanouts. The set of XML routers evaluated under the second priority is further limited to those XML routers which also equally satisfy the first priority, if there is more than one such XML router. The set of XML routers evaluated under the third priority is yet further limited to those XML routers which also equally satisfy the second priority, if there is more than one such XML router. The set of XML routers evaluated under the tie-breaking mechanism is yet further limited to those XML routers which also satisfy the third priority, if there is more than one such XML router.

Referring to FIG. 7, the method of determining priority using the TCP hops metric is shown according to one embodiment of the invention. At step 170 the new XML router determines which XML router or XML routers have a least number of TCP hops, the TCP hops having been determined as explained above with reference to step 146 of FIG. 6. At step 172 the new XML router returns the identity of each XML router satisfying this particular priority, that is each XML router having the least number of TCP hops. The number of XML routers which are returned at step 172 is used by the new XML router when determining whether more than one router satisfies the priority, as described above with reference to steps 152, 158, and 162 of FIG. 5.

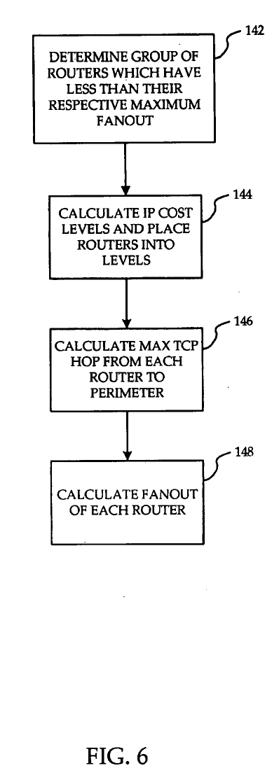

Referring to FIG. 8, the method of determining priority using the IP cost levels is shown according to one embodiment of the invention. At step 180 the new XML router determines which XML router or XML routers have a lowest IP cost level, the IP cost levels having been determined as explained above with reference to step 144 of FIG. 6. At step 182 the new XML router returns the identity of each XML router satisfying this particular priority, that is each XML router having the lowest IP cost level. The number of XML routers which are returned at step 182 is used by the new XML router when determining whether more than one router satisfies the priority, as described above with reference to steps 152, 158, and 162 of FIG. 5.

Referring to FIG. 9, the method of determining priority using the fanout when the fanout parameterization type is “greatest fanout” is shown according to one embodiment of the invention. At step 190 the new XML router determines which XML router or XML routers have a greatest fanout, the fanout having been determined as explained above with reference to step 148 of FIG. 6. At step 192 the new XML router returns the identity of each XML router satisfying this particular priority, that is each XML router having the greatest fanout. The number of XML routers which are returned at step 192 is used by the new XML router when determining whether more than one router satisfies the priority, as described above with reference to steps 152, 158, and 162 of FIG. 5.

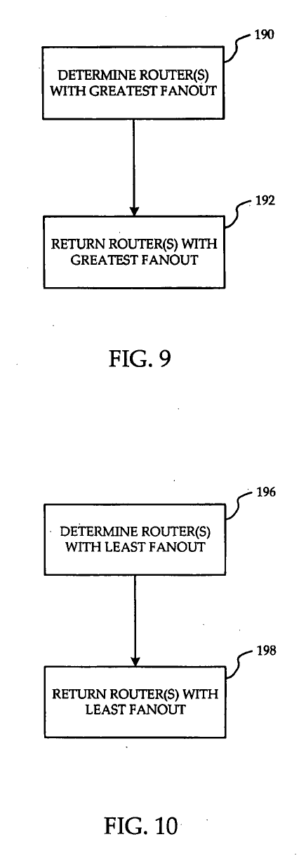

Referring to FIG. 10, the method of determining priority using the fanout when the fanout parameterization type is “least fanout” is shown according to one embodiment of the invention. At step 196 the new XML router determines which XML router or XML routers have a least fanout, the fanout having been determined as explained above with reference to step 148 of FIG. 6. At step 198 the new XML router returns the identity of each XML router satisfying this particular priority, that is each XML router having the least fanout. The number of XML routers which are returned at step 198 is used by the new XML router when determining whether more than one router satisfies the priority, as described above with reference to steps 152, 158, and 162 of FIG. 5.

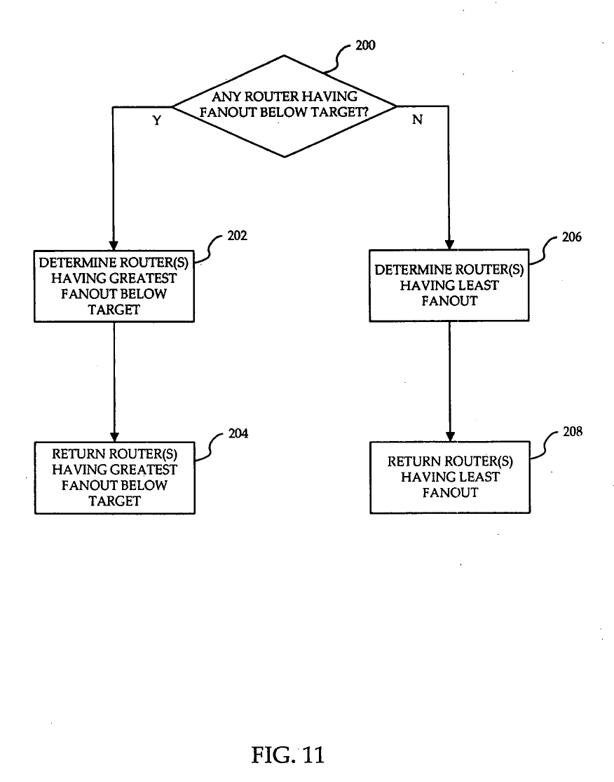

Referring to FIG. 11, the method of determining priority using the fanout when the fanout prioritization type is “target fanout” is shown according to one embodiment of the invention. A fanout prioritization type of “target fanout” is used to identify XML routers that have the greatest fanout that falls below the target value. If there are no such XML routers, then the XML router or routers having the lowest fanout (which will be above the target value) are identified. At step 200 the new XML router determines whether any XML routers have a current fanout below the target fanout, the fanout having been determined as explained above with reference to step 148 of FIG. 6. If any XML routers have a current fanout below the target fanout, then at step 202 the new XML router determines which XML router or XML routers have a greatest fanout below the fanout target value. At step 198 the new XML router returns the identity of each XML router satisfying this particular priority, that is each XML router having the greatest fanout below the fanout target value. If at step 200 no XML routers have a current fanout below the target fanout, then at step 206 the new XML router determines which XML router or XML routers have a least fanout. At step 208 the new XML router returns the identity of each XML router satisfying this particular priority, that is each XML router having the least fanout. The number of XML routers which are returned at step 204 or step 208 is used by the new XML router when determining whether more than one router satisfies the priority, as described above with reference to steps 152, 158, and 162 of FIG. 5.

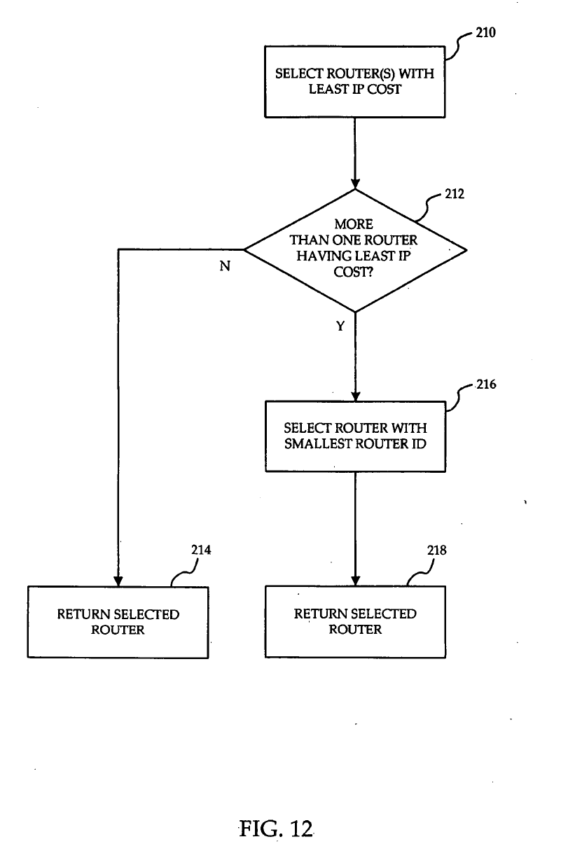

Referring to FIG. 12, the method of the tie-break mechanism is shown according to one embodiment of the invention. This method will be carried out by the new XML router if there more than one XML router has a current fanout lower than the maximum fanout of the XML router, has the lowest TCP hops, has the lowest IP cost level, and satisfies the fanout priority. In such an eventuality, a single XML router is selected by considering first the actual IP cost (as opposed to the coarser IP cost level), and failing that distinction, by selecting the router with the lowest router ID. At step 210 the new XML router determines the XML router or XML routers having the lowest IP cost. If at step 212 it is determined that only one XML router has the lowest IP cost, then at step 214 the new XML router returns the identity of the single XML router having the lowest IP cost. If at step 212 it is determined that more than one XML router has the lowest IP cost, then at step 216 the new XML router selects from the XML routers having the lowest IP cost the XML router having the lowest router ID, for example the lowest IP address. At step 218 the new XML router returns the identity of the single XML router having the lowest IP cost.

When choosing the type of fanout priority an operator will take into account the order of metrics for the priorities chosen and the particular goals the topology needs to meet in the context of the particular capabilities of the XML routers and underlying physical network. For example, in a set of priorities where the fanout priority is the first priority the fanout priority type should probably be chosen to be greatest fanout, or target fanout, otherwise a line topology would result if all XML routers were added according to the same set of priorities. In cases where the XML routers do not all have the same order of metrics in the priorities and in cases where the fanout priority is not the first priority, any one of the greatest fanout, least fanout, and target fanout priority type may be chosen for the XML router. In cases where TCP hops are of a more primary priority than fanout, an operator may choose to set the type of fanout priority to greatest fanout priority to further minimize the overall number of TCP hops in the network. Conversely in some cases where fanout is of a more primary priority than TCP hops, an operator may choose to set the type of fanout priority to least fanout priority if minimizing the overall number of TCP hops in the network is less important. Alternatively, an operator may know that a certain target number of adjacencies per router is ideal in the particular operating context of the XML network, in which case the fanout priority type would be set to target fanout priority.

In determining the order of the metrics in the priorities themselves the operator has many considerations to make in the trade off among fanout, TCP hops, and IP cost. Higher fanout throughout the network generally results in lower latency through the network, but more replication effort required from the routers, and a larger routing database due to the lack of route aggregation at intermediate points in the network. If a router has dedicated hardware or otherwise optimized resources for replication, fanout can be set higher than for routers which are not optimized for replication or for routers which use software with scarce resources. Persons skilled in the art however understand that increasing fanout indefinitely would not scale well in large networks. Ensuring there is a maximum fanout for each router is useful in this respect. Lower TCP hops throughout the network generally results in lower latency through the network, and larger routing database sizes due to a lack of aggregation at intermediate points in the network. Reducing IP cost will generally reduce the overall resource and network bandwidth requirements.

Persons skilled in the art will generally be able to determine based upon the context of the particular application layer network they are implementing and the capabilities of the application routers and underlying physical network utilized, which of the types of fanout priorities should be used, and how each of the three metrics, namely, IP cost, TCP hops, and fanout should be prioritized to best meet their needs.

The invention has been described as having the prioritization parameters (the relative priorities of the three metrics and the fanout parameterization type) all set by an operator. Alternatively, the operator need not set all three priorities, and need not define which type of the fanout prioritization is to be used. In embodiments which do not require the operator to set all three priorities or do not require the operator to set the fanout prioritization type, a default priority order and a default fanout prioritization type can be set, which can then be partially or fully overwritten by the operator. Optimization during generation of the topology of the network would then proceed by dealing with the operator parameters first and then by dealing with the defaults parameters to arrive at a final XML router to establish adjacency with the router being added.

The invention has been described with the prioritization of metrics set by an operator when the connectivity of a newly added XML router is to be determined. This allows the greatest flexibility in designing the network, as the prioritization can be set for each XML router as it is added and each new XML router can select its neighbours using priorities specific to itself. In an alternative embodiment, a master router is used to determine the connectivity of each newly added XML router, and applies the same metric prioritization for each newly added XML router. The master router sends the common prioritization to the control plane of each newly added XML router, which determines its connectivity using the common metric prioritizations. Although such an embodiment does not provide as much flexibility in designing the XML network topology, it has the advantage of being faster and simpler.

The invention has been described using three fanout prioritization types and a target fanout value. In one embodiment these are combined into a single value defining both the fanout prioritization type and the target fanout value. For example, a target fanout value of “1” can be used to indicate a fanout prioritization type of “least fanout”, a target fanout value of “99” (or some other high number) can be used to indicate a fanout prioritization type of “greatest fanout”, and any other number used to indicate both a fanout prioritization type of “target fanout” and the target fanout value. In fact, in such an embodiment, only the single method described with reference to FIG. 11 is needed, as the logic of the method using such target fanout values results in the same logic as described with reference to FIG. 9 and FIG. 10 for their respective fanout prioritization types.

The invention has been described as using the lowest router ID as the final tie-breaker for XML routers which are equivalent by all other measures. Alternatively the XML router having the greatest router ID may be selected. Indeed, any method of categorically selecting a single XML router using a value unique to each XML router may be used by selecting the XML router whose unique value satisfies a predetermined criterion.

Although the preferred embodiment of the invention is exemplary of a content based XML network including XML routers, XML router discovery, and generation of XML network topology, the invention contemplates any kind of content based application layer network, its routers, router discovery and content based application layer network topology generation in general.

The invention has been described as using prioritized metrics to establish adjacency for a newly added XML router, and using timers and the exchange of hello messages identifying neighbours in order to effect network discovery. Alternatively, once prioritized metrics are used to select an existing XML router with which a newly added XML router establishes adjacency, other means may be used to effect network discovery. Similarly, the use of timers and the exchange of hello messages identifying neighbours may be used to effect network discovery in networks that have been created using other adjacency determination methods.

The methods of the invention are preferably executed in a distributed manner by the control logic on the new XML router being added to the XML router, either as software instructions executable by a processor, by hardware logic within the XML router, or a combination of software and hardware. Alternatively, the methods may be executed centrally by an XML control plane server with access to the new XML router and to each existing XML router in the network, in which case the methods are in the form of software instructions executable by a processor. In either case, if the methods are executed partially or wholly as software instructions, then the software instructions may be stored on computer-readable media.

The embodiments presented are exemplary only and persons skilled in the art would appreciate that variations to the embodiments described above may be made without departing from the spirit of the invention. The scope of the invention is solely defined by the appended claims.

We claim:

1. A method of creating an extensible mark-up language (XML) network, comprising:
adding a new XML router to a group of existing XML routers by registering the new XML router with a rendezvous point of an XML router discovery group;
intermittently broadcasting a hello message from each XML router to all other XML routers in the group;
at each XML router, maintaining at least one timer, each timer associated with one of at least one adjacent XML router;
if one of the at least one timer at one of the XML routers expires before receipt of a hello message from the adjacent XML router associated with the timer, broadcasting to all other XML routers that the adjacent XML router is not a neighbour of the XML router at which the timer expired.

2. The method of claim 1 wherein each hello message identifies the originating XML router by a Universal Resource Identifier (URI) of the originating XML router, and identifies XML routers adjacent to the originating XML router by a URI of each adjacent XML router.

3. The method of claim 1 further comprising:
selecting one of the existing XML routers by determining which of at least two existing XML routers best satisfies prioritized metrics; and
establishing adjacency between the new XML router and the selected XML router.

4. The method of claim 3 wherein the prioritized metrics comprise:
an application layer hop metric relating to the number of application layer hops through the existing XML router to a farthest XML router;
an IP cost metric relating to the IP cost of reaching the existing XML router from the new XML router; and
a fanout metric relating to a fanout of the existing XML router.

5. The method of claim 4 further comprising defining a fanout prioritization type, and wherein determining which XML router best satisfies the fanout metric is dependent on the fanout prioritization type.

6. The method of claim 5 wherein the fanout prioritization type is one of “greatest fanout”, “least fanout”, and “target fanout”, and wherein determining which XML router best satisfies the fanout metric comprises:
selecting at least one XML router having a greatest fanout if the fanout prioritization type is “greatest fanout”;
selecting at least one XML router having a lowest fanout if the fanout prioritization type is “least fanout”;
selecting at least one XML router having a greatest fanout below a fanout target value if the fanout prioritization type is “target fanout” and at least one XML router has a fanout lower than the fanout target value; and
selecting at least one XML router having a lowest fanout if the fanout prioritization type is “target fanout” and no XML router has a fanout lower than the fanout target value.

7. The method of claim 3 further comprising selecting a subset of the existing XML routers for which a fanout of the XML router is less than a maximum fanout assigned to the XML router, and wherein selecting one of the existing XML routers comprises selecting one of the XML routers in the subset.

8. The method of claim 7 wherein the prioritized metrics comprise:
an application layer hop metric relating to the number of application layer hops through the existing XML router to a farthest XML router;
an IP cost metric relating to the IP cost of reaching the existing XML router from the new XML router; and
a fanout metric relating to the fanout the existing XML router.

9. The method of claim 8 further comprising defining a plurality of ordered IP cost levels, each IP cost level defining a range of IP costs, and wherein the IP cost metric for an XML router is defined by the IP cost level in which the IP cost of the XML router lies.

10. The method of claim 7 wherein selecting one of the XML routers in the subset comprises:
selecting at least one XML router in the subset which best satisfies the metric associated with a first priority;
if more than one XML router in the subset best satisfies the metric associated with the first priority, selecting at least one XML router which best satisfies the metric associated with the first priority and which best satisfies the metric associated with the second priority;
if more than one XML router in the subset best satisfies the metric associated with the first priority and best satisfies the metric associated with the second priority, selecting at least one XML router which best satisfies all three metrics; and
if more than one XML router in the subset best satisfies all three metrics, selecting one of the XML routers which best satisfies all three metrics by performing a tie-breaking routine on all XML routers in the subset which best satisfy all three metrics.

11. The method of claim 10 wherein performing a tie-breaking routine comprises:
selecting at least one XML router which best satisfies all three metrics and which has a lowest IP cost; and
if more than one XML router best satisfies all three metrics and has a lowest IP cost, selecting the XML router which best satisfies all three metrics and has the lowest IP cost and which has a unique value which satisfies a predetermined criterion.

12. The method of claim 11 wherein the unique value is an identification of the XML router, and wherein the predetermined criterion is the lowest identification.

13. The method of claim 3 further comprising:
selecting a subset of the existing XML routers for which a fanout of the XML router is less than a maximum fanout assigned to the XML router, and wherein selecting one of the existing XML routers comprises selecting one of the XML routers in the subset;
selecting at least one XML router in the subset which best satisfies the metric associated with a first priority;
if more than one XML router in the subset best satisfies the metric associated with the first priority, selecting at least one XML router which best satisfies the metric associated with the first priority and which best satisfies the metric associated with the second priority;
if more than one XML router in the subset best satisfies the metric associated with the first priority and best satisfies the metric associated with the second priority, selecting at least one XML router which best satisfies all three metrics;
if more than one XML router in the subset best satisfies all three metrics, selecting at least one XML router which best satisfies all three metrics and which has a lowest IP cost, and if more than one XML router best satisfies all three metrics and has a lowest IP cost, selecting the XML router which best satisfies all three metrics and has the lowest IP cost and which has a unique value which satisfies a predetermined criterion;
wherein the prioritized metrics comprise an application layer hops metric relating to the number of application layer hops through the existing XML router to a farthest XML router, an IP cost metric relating to the IP cost of reaching the existing XML router from the new XML router, and a fanout metric relating to a fanout of the existing XML router;
wherein the IP cost metric for an XML router is defined by an IP cost level in which the IP cost of the XML router lies, each IP cost level defining a range of IP costs; and
wherein determining at least one XML router which best satisfies the fanout metric comprises:
defining a fanout prioritization type being one of “greatest fanout”, “least fanout”, and “target fanout”;
selecting at least one XML router having a greatest fanout if the fanout prioritization type is “greatest fanout”;
selecting at least one XML router having a lowest fanout if the fanout prioritization type is “least fanout”;
selecting at least one XML router having a greatest fanout below a fanout target value if the fanout prioritization type is “target fanout” and at least one XML router has a fanout lower than the fanout target value; and
selecting at least one XML router having a lowest fanout if the fanout prioritization type is “target fanout” and no XML router has a fanout lower than the fanout target value.

14. A method of adding an XML router to an existing XML network having at least one existing XML router, comprising:
selecting one of the existing XML routers by determining which of at least two existing XML routers best satisfies prioritized metrics; and
establishing adjacency between the new XML router and the selected XML router.

15. The method of claim 14 wherein the prioritized metrics comprise:
an application layer hop metric relating to the number of application layer hops through the existing XML router to a farthest XML router;
an IP cost metric relating to the IP cost of reaching the existing XML router from the new XML router; and
a fanout metric relating to a fanout of the existing XML router.

16. The method of claim 15 further comprising defining a fanout prioritization type, and wherein determining which XML router best satisfies the fanout metric is dependent on the fanout prioritization type.

17. The method of claim 16 wherein the fanout prioritization type is one of “greatest fanout”, “least fanout”, and “target fanout”, and wherein determining which XML router best satisfies the fanout metric comprises:
selecting at least one XML router having a greatest fanout if the fanout prioritization type is “greatest fanout”;
selecting at least one XML router having a lowest fanout if the fanout prioritization type is “least fanout”;
selecting at least one XML router having a greatest fanout below a fanout target value if the fanout prioritization type is “target fanout” and at least one XML router has a fanout lower than the fanout target value; and
selecting at least one XML router having a lowest fanout if the fanout prioritization type is “target fanout” and no XML router has a fanout lower than the fanout target value.

18. The method of claim 14 further comprising selecting a subset of the existing XML routers for which a fanout of the XML router is less than a maximum fanout assigned to the XML router, and wherein selecting one of the existing XML routers comprises selecting one of the XML routers in the subset.

19. The method of claim 18 wherein the prioritized metrics comprise:
an application layer hop metric relating to the number of application layer hops through the existing XML router to a farthest XML router;
an IP cost metric relating to the IP cost of reaching the existing XML router from the new XML router; and
a fanout metric relating to the fanout of the existing XML router.

20. The method of claim 19 further comprising defining a plurality of ordered IP cost levels, each IP cost level defining a range of IP costs, and wherein the IP cost metric for an XML router is defined by the IP cost level in which the IP cost of the XML router lies.

21. The method of claim 18 wherein selecting one of the XML routers in the subset comprises:
selecting at least one XML router in the subset which best satisfies the metric associated with a first priority;
if more than one XML router in the subset best satisfies the metric associated with the first priority, selecting at least one XML router which best satisfies the metric associated with the first priority and which best satisfies the metric associated with the second priority;
if more than one XML router in the subset best satisfies the metric associated with the first priority and best satisfies the metric associated with the second priority, selecting at least one XML router which best satisfies all three metrics; and
if more than one XML router in the subset best satisfies all three metrics, selecting one of the XML routers which best satisfies all three metrics by performing a tie-breaking routine on all XML routers in the subset which best satisfy all three metrics.

22. The method of claim 21 wherein performing a tie-breaking routine comprises:
selecting at least one XML router which best satisfies all three metrics and which has a lowest IP cost; and
if more than one XML router best satisfies all three metrics and has a lowest IP cost, selecting the XML router which best satisfies all three metrics and has the lowest IP cost and which has a unique value which satisfies a predetermined criterion.

23. The method of claim 22 wherein the unique value is an identification of the XML router, and wherein the predetermined criterion is the lowest identification.

24. The method of claim 14 further comprising:
selecting a subset of the existing XML routers for which a fanout of the XML router is less than a maximum fanout assigned to the XML router, and wherein selecting one of the existing XML routers comprises selecting one of the XML routers in the subset;
selecting at least one XML router in the subset which best satisfies the metric associated with a first priority;
if more than one XML router in the subset best satisfies the metric associated with the first priority, selecting at least one XML router which best satisfies the metric associated with the first priority and which best satisfies the metric associated with the second priority;
if more than one XML router in the subset best satisfies the metric associated with the first priority and best satisfies the metric associated with the second priority, selecting at least one XML router which best satisfies all three metrics;
if more than one XML router in the subset best satisfies all three metrics, selecting at least one XML router which best satisfies all three metrics and which has a lowest IP cost, and if more than one XML router best satisfies all three metrics and has a lowest IP cost, selecting the XML router which best satisfies all three metrics and has the lowest IP cost and which has a unique value which satisfies a predetermined criterion;
wherein the prioritized metrics comprise an application layer hops metric relating to the number of application layer hops through the existing XML router to a farthest XML router, an IP cost metric relating to the IP cost of reaching the existing XML router from the new XML router, and a fanout metric relating to a fanout of the existing XML router;
wherein the IP cost metric for an XML router is defined by an IP cost level in which the IP cost of the XML router lies, each IP cost level defining a range of IP costs; and
wherein determining at least one XML router which best satisfies the fanout metric comprises:
defining a fanout prioritization type being one of “greatest fanout”, “least fanout”, and “target fanout”;
selecting at least one XML router having a greatest fanout if the fanout prioritization type is “greatest fanout”;
selecting at least one XML router having a lowest fanout if the fanout prioritization type is “least fanout”;
selecting at least one XML router having a greatest fanout below a fanout target value if the fanout prioritization type is “target fanout” and at least one XML router has a fanout lower than the fanout target value; and
selecting at least one XML router having a lowest fanout if the fanout prioritization type is “target fanout” and no XML router has a fanout lower than the fanout target value.
